(19) United States
(12) Patent Application Publication
(10) Pub. No.: US 2022/0019339 A1
(43) Pub. Date: Jan. 20, 2022

(54) RELATIONSHIP VISUALIZATIONS FOR MULTI-DIMENSIONAL DATA MODELS

(71) Applicant: AVEVA SOFTWARE, LLC, Lake Forest, CA (US)

(72) Inventors: Ravi Kumar Herunde Prakash, Lake Forest, CA (US); Sami Majed Abbushi, Mission Viejo, CA (US); Sung Chung, Walnut, CA (US); Christian-Marc Pouyez, Laval (CA); Ajith Kuzhikkali, Ramapuram, Chennai (IN); Patrick Parsy, Rancho Santa Margarita, CA (US); Rajakumar Sidhan, Salem (IN)

(21) Appl. No.: 17/360,883

(22) Filed: Jun. 28, 2021

Related U.S. Application Data
(63) Continuation of application No. 16/775,838, filed on Jan. 29, 2020.
Application No. 16/775,838 is a continuation of application No. 15/826,887, filed on Nov. 30, 2017, now abandoned.

(51) Int. Cl. G06F 3/0484; G06T 11/20; G06N 5/02; G06F 3/0482; G06F 16/532; G06F 16/26

(52) U.S. Cl. CPC G06F 3/04842; G06T 11/206; G06N 5/02; G06N 5/022; G06F 16/532; G06F 16/26; G06F 3/0482

(57) ABSTRACT

Providing visualizations of relationships among multi-dimensional data models for manufacturing intelligence systems. Storing configuration data in an intelligence data store under a configuration schema enables a multi-dimensional model visualization. The multi-dimensional data model visualization depicts all of the many-to-many, dynamic relationships between objects in a single display.

### CROSS REFERENCE TO RELATED APPLICATIONS

This application is a continuation of U.S. application Ser. No. 16/775,838, filed Jan. 29, 2020, entitled “RELATIONSHIP VISUALIZATIONS FOR MULTI-DIMENSIONAL DATA MODELS”, which is a continuation of U.S. application Ser. No. 15/826,887, filed Nov. 30, 2017, entitled “RELATIONSHIP VISUALIZATIONS FOR MULTI-DIMENSIONAL DATA MODELS”, the disclosures of which are hereby incorporated by reference in their entireties for all purposes.

### TECHNICAL FIELD

Aspects of the present disclosure generally relate to manufacturing intelligence. More particularly, aspects relate to systems and methods for providing visualizations of relationships among multi-dimensional data models for manufacturing intelligence systems.

### BACKGROUND

Manufacturing intelligence systems provide graphical representations of information models that are multidimensional data models to represent business logic and relationships between various unstructured source data items. Conventional systems graphically represent many-to-many object relationships in a hierarchical manner. The hierarchical representations result in an unwieldy visualization that fails to provide an overview of relationships among the objects while authoring the model and creating dashboards, requires users to make multiple selections (e.g., mouse clicks) to open multiple objects and tabs to explore object relationships, and is unable to handle updated object relationships and newly added objects.

### SUMMARY

In an aspect, a computing device includes an interface processor and a computer-readable storage medium storing processor-executable instructions. The interface processor is communicatively coupled, via a communications network and an intelligence data service, to one or more data sources storing data values corresponding to devices of a continuous process. The data values comprise a plurality of model objects. When executed by the interface processor, the instructions configure the computing device to generate for output graphical representations for a multi-dimensional data model. The graphical representations each represent an instance of one of the model objects. The multi-dimensional data model comprises the plurality of model objects and subsets of two or more of the model objects are related through hierarchical dependencies. The executing instructions further configure the client computing device to output for display the graphical representations in a non-hierarchical arrangement and receive an input to select one of the model objects by selecting the graphical representation representative of the model object. And the executing instructions configure the client computing device to output for display a filtered view of the graphical representations. The filtered view comprises the selected graphical representation and the graphical representations representing the subset of model objects dependent upon the model object represented by the selected graphical representation. The graphical representations representing the dependent model objects in the filtered view are graphically distinguished from the graphical representations representing the model objects that are independent of the model object represented by the selected graphical representation.

In other aspects, a computer implemented method and a computer readable storage device are provided.

Other objects and features will be in part apparent and in part pointed out hereinafter.

### BRIEF DESCRIPTION OF THE DRAWINGS

FIGS. 1 and 2 illustrate an exemplary system within which aspects of the disclosure may be incorporated.

FIGS. 3A-3H illustrate an exemplary configuration schema according to an embodiment.

FIG. 4 illustrates an exemplary dependency relationship among objects of a model according to an embodiment.

FIG. 5 illustrates an exemplary process of modifying a deployed data source object according to an embodiment.

FIG. 6 illustrates an exemplary process of obtaining a schema for a deployed data source object according to an embodiment.

FIGS. 7A-7C illustrate an exemplary graphical user interface according to an embodiment.

FIG. 8 illustrates an exemplary computing device architecture within which aspects of the disclosure may be implemented according to an embodiment.

Corresponding reference characters indicate corresponding parts throughout the drawings.

### DETAILED DESCRIPTION

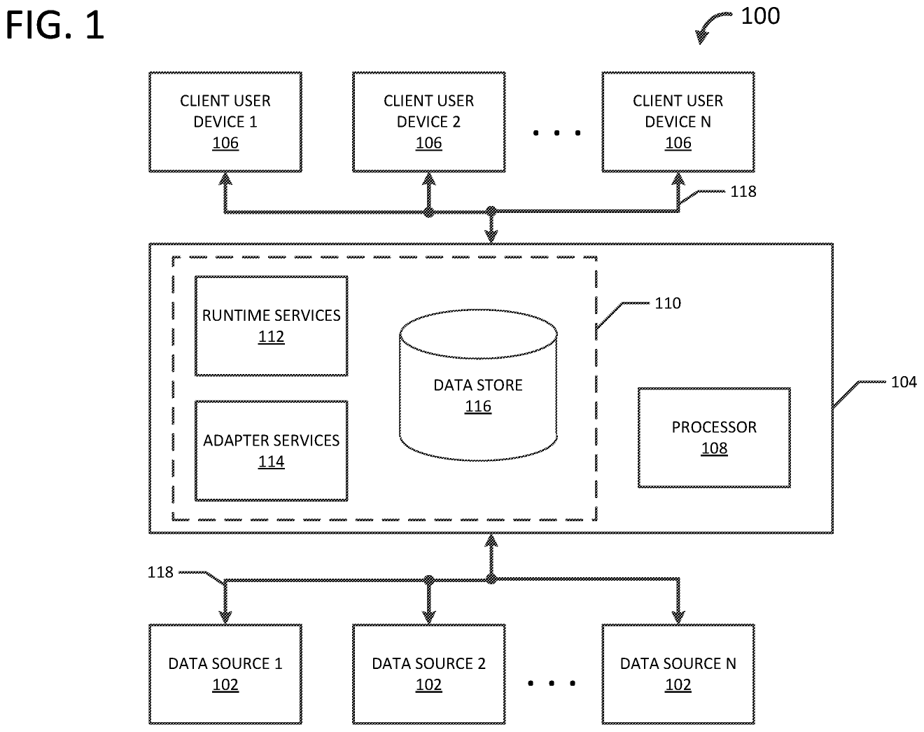

FIG. 1 illustrates an exemplary system, generally indicated at 100, within which an embodiment of the disclosure may be incorporated. The system 100 includes one or more data sources 102, a server computing device 104, and one or more client user devices 106. The server computing device 104 includes a processor 108 and intelligence data services 110. The intelligence data services 110 include runtime services 112, adapter services 114, and a data store 116. In an embodiment, aspects of system 100 are communicatively coupled via a communications infrastructure 118. In accordance with an aspect of the disclosure, intelligence data services 110 are embodied on a computer-readable memory storage device.

The data sources 102 are configured to store data indicative of one or more values corresponding to devices of a continuous process (e.g., a plant). In an exemplary embodiment, objects (e.g., measures or dimensions) comprise data stored on data sources 102. The data sources 102 are further configured to provide the stored data to the server computing device 104 via a communications network. In an embodiment, data sources 102 are connected to server computing device 104 via one or more plug-in components, such as data adapters (e.g., adapter services 114). The data sources 102 may each comprise a server computing device, an operational historian database, an object linking and embedding (OLE) database, a performance indicator (PI) historian database, and the like in accordance with an aspect of the disclosure. Exemplary data stored and provided by data sources 102 includes, but is not limited to, operations and performance data, operational historian data, OLE data, PI data, and the like.

The intelligence data services 110 are configured to, when executed by processor 108, retrieve, relate, and aggregate data from data sources 102. In accordance with an aspect of the disclosure, a measure is a group of one or more calculations that share the same context. In an embodiment, a measure comprises calculations for each source system, time period, and/or each unique combination of dimension value. Exemplary measures include, but are not limited to, sales volume, margin contribution, schedule adherence, energy deviation, performance, quality, run rate, target run rate, utilization, and the like.

In accordance with another aspect of the disclosure, a dimension is a structure that provides context to measures. In an embodiment, each dimension stores related items of data. In another embodiment, a dimension stores contextual data. A dimension enables filtering, grouping, and labeling of measure data, in accordance with an aspect of the disclosure. Exemplary dimensions include, but are not limited to, customer, product, shift, line, machine, equipment, item, job, and the like.

In accordance with a further aspect of the disclosure, relating a measure to a dimension establishes a context. In an embodiment, a context link provides a context for time-slicing and time-slices obtained from time defining dimensions may have an associated context. In an embodiment in which runtime services 112 process a measure, runtime services 112 validate and ensure that only one process is executed during a particular time range.

The communications infrastructure 118 is capable of facilitating the exchange of data among various components of system 100, including data sources 102, server computing device 104, and client user devices 106. The communications infrastructure 118 in the embodiment of FIG. 1 includes a local area network (LAN) that is connectable to other telecommunications networks, including other LANs or portions of the Internet or an intranet. The communications infrastructure 118 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, communications infrastructure 118 is any medium that allows data to be physically transferred through serial or parallel communication channels (e.g., copper wire, optical fiber, computer bus, wireless communication channel, etc.). In an embodiment, communications infrastructure 118 comprises at least in part a process control network. In another embodiment, communications infrastructure 118 comprises at least in part a supervisory control and data acquisition (SCADA) system. In yet another embodiment, communications infrastructure 118 comprises at least in part an enterprise manufacturing intelligence (EMI)/operational intelligence (0I) system.

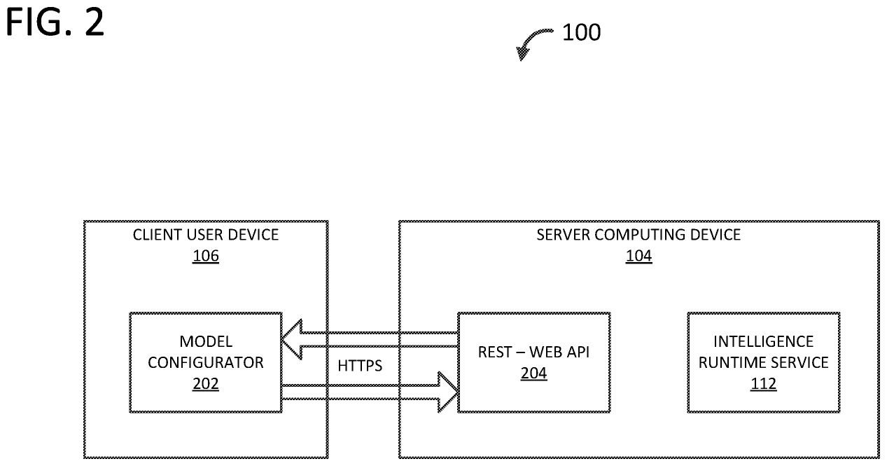

FIG. 2 illustrates an embodiment of the exemplary system in which the client user device 106 includes a model configurator 202 and the server computing device 104 includes a model application programming interface (API) 204. In an embodiment, the model API 204 comprises, at least in part, adapter services 114. In accordance with an aspect of the disclosure, the connection information of a data source (e.g., one or more data sources 102, etc.) contains sensitive information, such as user names and passwords and/or internal server names. At configuration time, this data needs to be protected while it is transmitted between components of system 100 and while it is saved in a persisted storage (e.g., one or more data sources 102, etc.). When a user configures connection information of a data source the data is transmitted between the model configurator 202 and the model API 204. During this transmission, the data is communicated in clear text but is protected via an HTTP over Transport Layer Security (HTTPS) communication protocol. Using a strict transport security (HSTS) enforces the use of HTTPS so that transmitting data in clear text is prevented.

The model API 204 controls all data writes into and data reads out of the configuration database. When model API 204 receives connection information to be written to the database, it encrypts that piece of data before saving it to the database. When model API 204 is requested to read data from the database, it decrypts the connection information before returning it. If data is requested directly from model API 204, the connection information is returned in encrypted format. As illustrated in FIG. 2, an HTTPS protocol protects credentials between client user device 106 and model API 204 and server computing device 104 encrypts and decrypts the credentials.

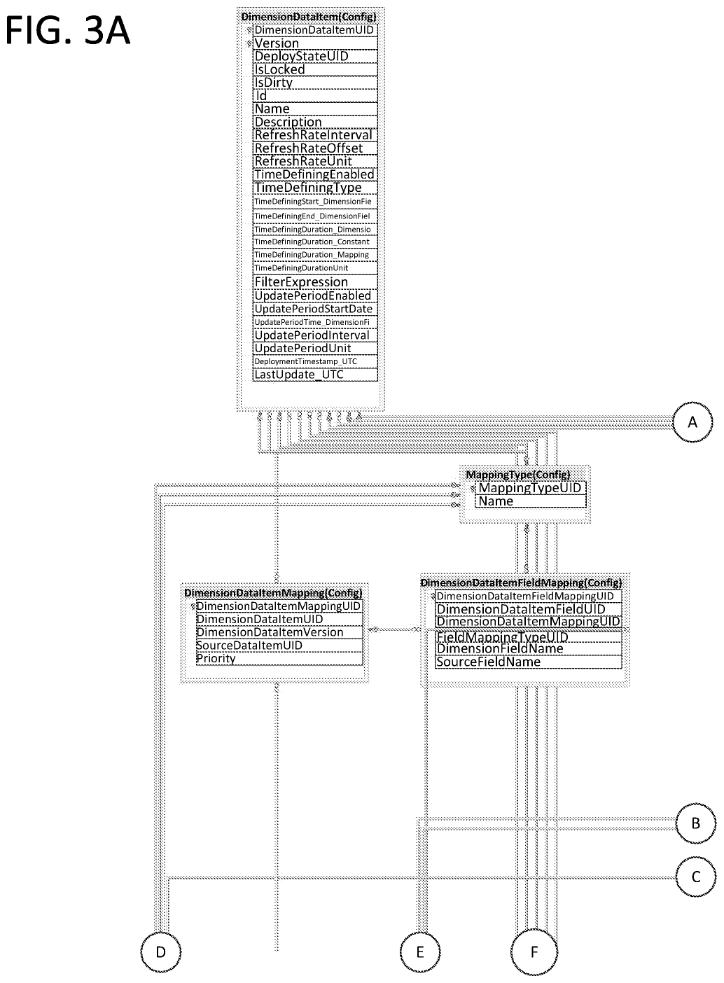

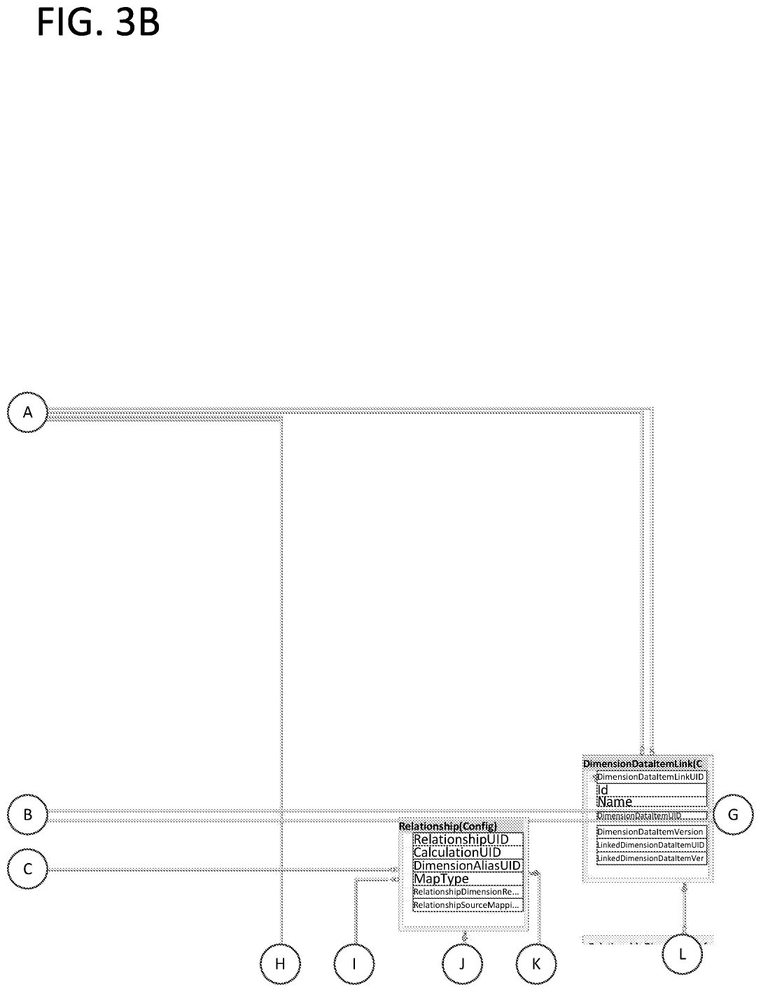

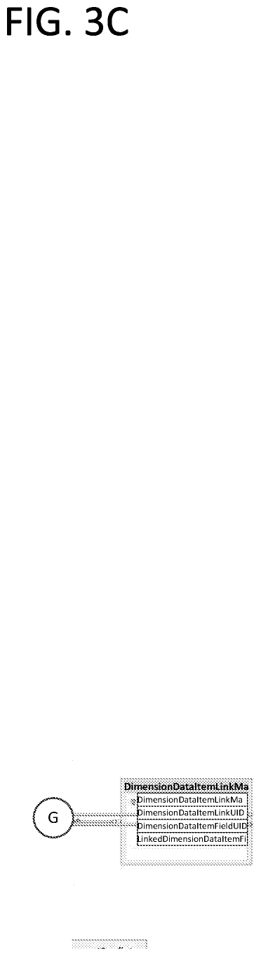

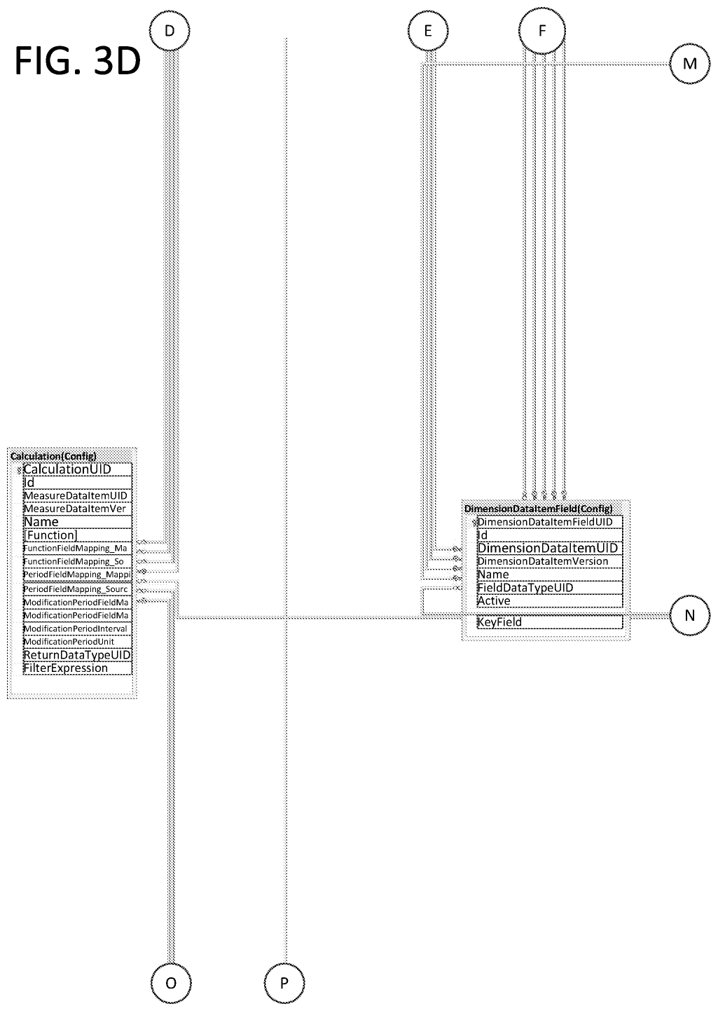

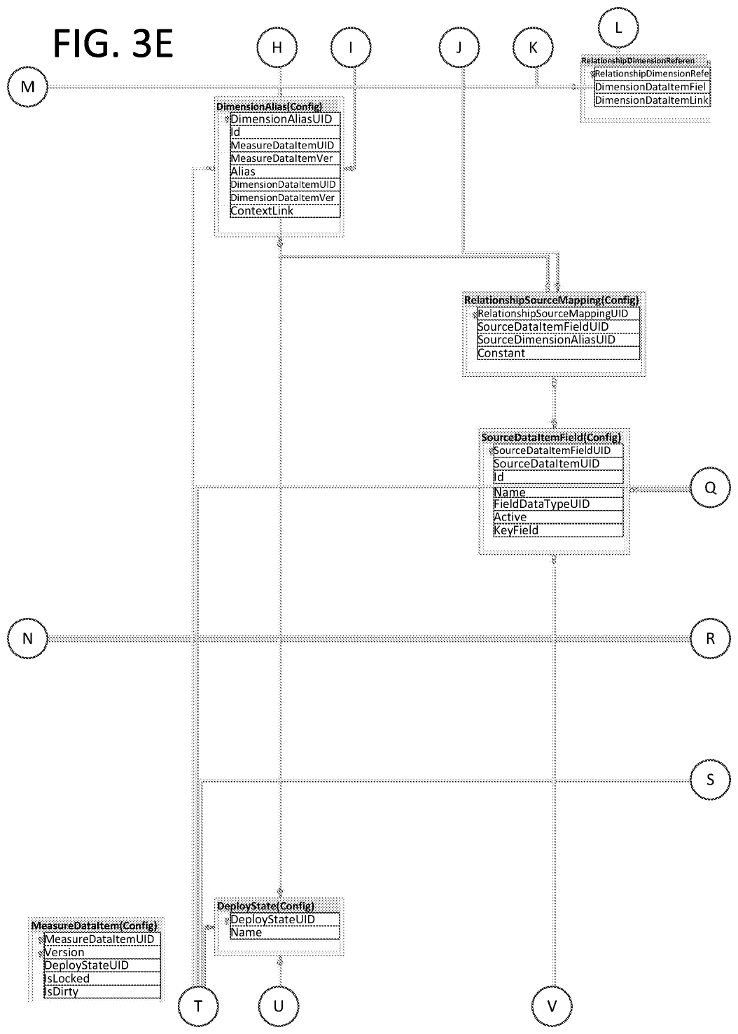

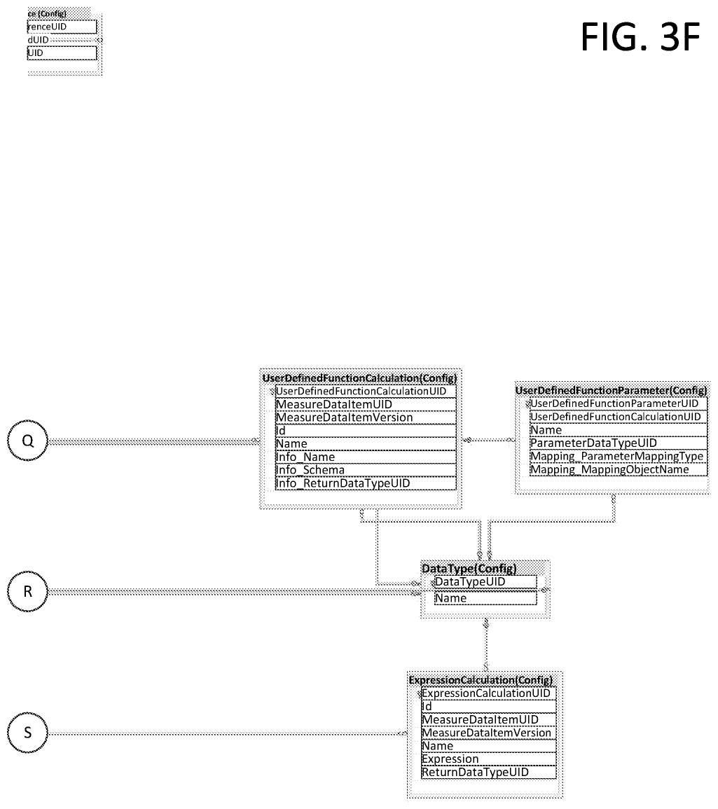

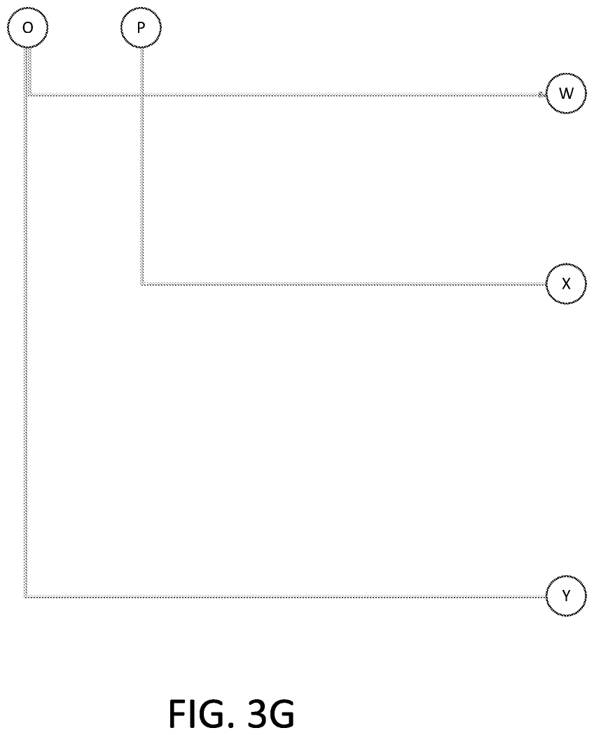

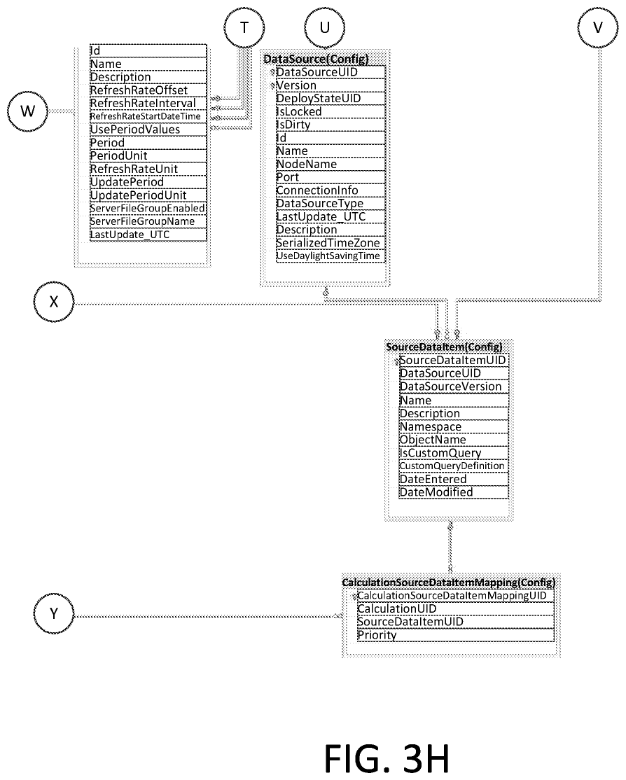

FIGS. 3A-3H illustrate an exemplary configuration schema (e.g., Config.DataSource, Config.DimensionDataltem, etc.) under which model configuration data is stored in an intelligence data store (e.g., data store 116) on server computing device 104. In an embodiment, the schema enables storage of multi-dimensional data models. For example, data about a dimension may be stored in a table defined by Table 1.

TABLE 1

| Column Name | Data Type | Is Nullable | Default | Comment |
|---|---|---|---|---|
| DimensionDataltemUID | Integer | No | Autogenerated | Identifies the |
| | | | | dimension. |
| Id | Uniqueldentifier | No | Autogenerated | The identifier |
| | | | | that is used for |
| | | | | any |
| | | | | relationships. |
| DeployStateUID | Tinylnteger | No | 0 | 0 = Not |
| | | | | Deployed, 1 = |
| | | | | Deployed |
| Name | Nvarchar(32) | No | Auto-suggested | The dimension |
| | | | | name |
| Description | Nvarchar(1024) | Yes | None | User |
| | | | | description of |
| | | | | the dimension |
| RefreshRateIntervaI | Integer | No | 1 | The configured |
| | | | | refresh interval |
| | | | | number (e.g., 1 |
| | | | | day, etc.) |
| RefreshRateOffset | Integer | No | 0 | An offset |
| | | | | against the |
| | | | | configured |
| | | | | refresh |
| RefreshRateUnit | Nvarchar(20) | No | “Day” | Describes the |
| | | | | refresh rate |
| | | | | interval (e.g., |
| | | | | Day, Hour, |
| | | | | Minute) |

Once an object is deployed to a runtime environment, model API 204 prevents changes to the deployed object. To enable users to continue working with the object after deployment to the runtime environment, model API 204 creates a copy of the object if it detects any requested changes. In this manner, the user works against a copy of the object that can later be used to re-deploy the changes.

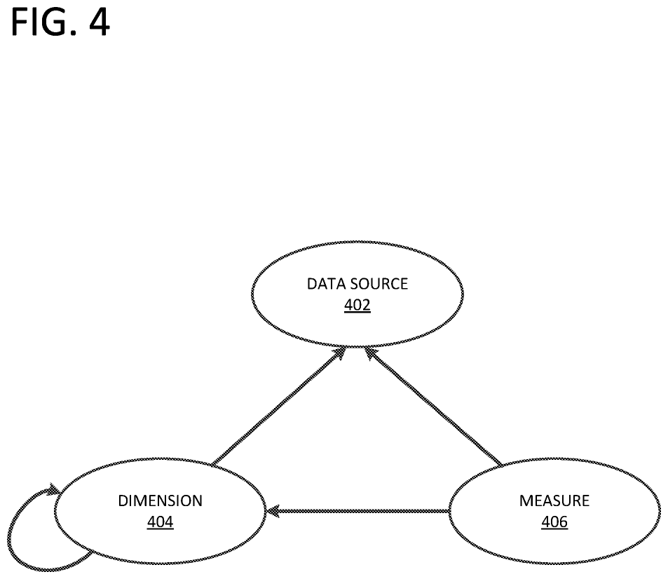

FIG. 4 illustrates an exemplary dependency relationship among objects of a model. Whenever an object is opened in the model builder it references and displays, as applicable, the latest version of all of its dependee objects regardless of deployment state. As illustrated in FIG. 4, the Data Source object 402 is dependent upon both the Dimension object 404 and the Measure object 406 and has no dependees of its own. The Dimension object 404 is dependent upon the Measure object 406 and the dependees of the Dimension object 404 are itself and the Data Source object 402. The Measure object 406 is not dependent upon any other object and the dependees of the Measure object 406 are the Dimension object 404 and the Data Source object 402. In an embodiment, the exemplary dependency relationship is based upon the assumption that only one model builder is connected to the model builder service at a time and only one object at a time is loaded by the model builder.

When a dependee object that is deployed is further modified and saved and a dependent object is opened, the dependent object will automatically (e.g., without an explicit edit action or a checkout, etc.) load the dependencies based on the latest version of the dependee object and not the deployed version. Any saved modifications to the dependee object as seen from within a dependent object are reconciled with a dependent object as required. In an embodiment, a dependent object cannot be deployed when a corresponding dependee object is in an undeployed state or is in a deployed state with pending changes. For example, client user device 102 may display a message to the user indicating the dependee objects that should be deployed. In another embodiment, an object cannot be deleted if there are one or more objects dependent upon that object. The dependencies will first need to be removed to delete the object.

From a database perspective, objects are identified by a composite key that includes an object unique ID (xUID) and a version number. For example, a data source object is identified by a composite key that includes a DataSourceUID and Version. In the example of a deployed data source, to which a user may make further changes, Version 1 and Version 2 exist for the same object, as shown in Table 2.

TABLE 2

| DataSourceUID | Version | Deploy StateUID |
|---|---|---|
| 1 | 1 | 1 |
| 1 | 2 | 0 |

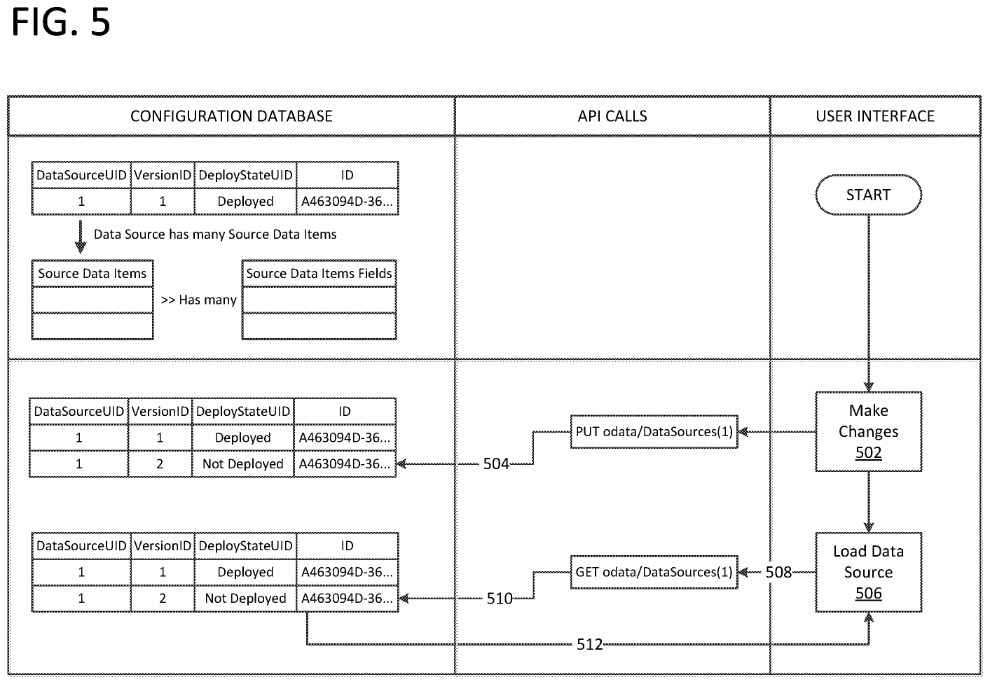

The first row, Version 1, represents the deployed data source object, which is protected from changes. The second row, Version 2, represents the copy of the deployed data source object, which is the target of any future changes. FIG. 5 illustrates an exemplary process of modifying a deployed data source object. One of ordinary skill in the art will understand that a similar process may be used for other data model objects (e.g., Dimensions, Measures, etc.). As illustrated in FIG. 5, the left lane represents a configuration database, the middle lane represents API calls made from the model builder, and the right lane represents the user interface.

As illustrated in the configuration database pane, a data source object having a UID of 1 and a Version ID of 1 exists in a deployed state. The data source object may include many source data items which in turn may include many source data item fields. The process beings when a user, via the user interface of client user device 102, makes changes to the data source object at 502 via a call to model API 204. The model API 204 generates, at 504, a Version 2 for the data source object because Version 1 is in a deployed state. At 506, the user, via the user interface of client user device 102, loads the data source object into an editor (e.g., model builder). The client user device 102 makes a request API call at 508 and model API 204 gets Version 2 at 510. In response, the configuration database returns 512 a user interface to client user device 102 with the Version 2 object state being “deployed with changes.” In this manner, the model builder (e.g., user interface) sees the latest version (e.g., Version 2 in this example) and the intelligence runtime service 112 sees the deployed version (e.g., Version 1 in this example) as long as the object is deployed. Upon a re-deploy operation, Version 2 becomes Version 1, Version 1 gets deployed, and Version 2 is deleted.

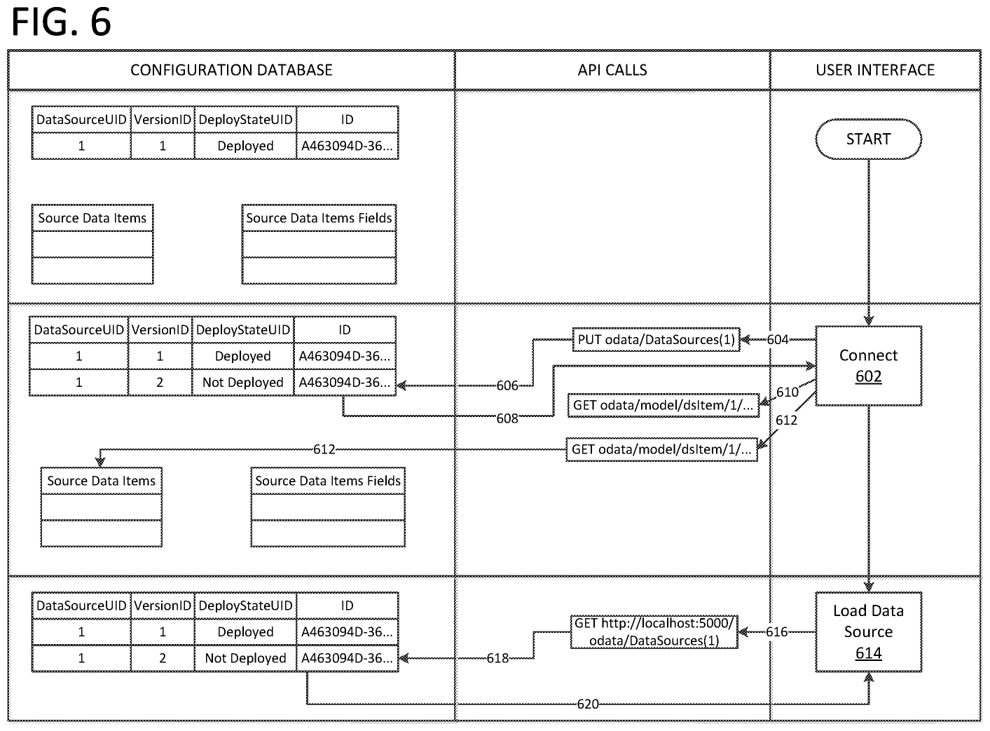

When a user initiates a connection from within a data source editor (e.g., by selecting/clicking a “Connect” button on the graphical user interface, etc.), the model builder makes a plurality of calls to model API 204. FIG. 6 illustrates an exemplary process of obtaining a schema for a data source object that is already deployed. One of ordinary skill in the art will understand that a similar process may be used for other data model objects (e.g., Dimensions, Measures, etc.). As illustrated in FIG. 6, the left lane represents a configuration database, the middle lane represents API calls made from the model builder, and the right lane represents the user interface.

The process begins when the user, via the user interface of client user device 102, initiates the connection at 602. This event triggers a Get Schema that includes four other events. At 604, the data source is updated. This, in effect, triggers model API 204 to create, at 606, a Version 2 when the data source object is in a deployed state. When Version 2 is created Version 1 stays unchanged. The source data items and source data item fields of Version 1 are also unchanged (i.e., Version 1 keeps its source data items and fields). At 608, model API 204 responds with an HTTP 201 (created) response. At 610, the model builder requests a list of data items and model API 204 pulls them from the data adapter. At 612, the model builder makes individual calls to get each source data item (i.e., one call for each data item). Any subsequent calls to the model API 204 will return Version 2. In this manner model API 204 logically pulls the highest version available.

At 614, the user, via the user interface of client user device 102, loads the data source object into an editor (e.g., model builder). The client user device 102 makes a request API call at 616 and model API 204 gets Version 2 at 618. In response, the configuration database returns 620 a user interface to client user device 102 with the Version 2 object state being “deployed with changes.” In this manner, the model builder (e.g. user interface) sees the latest version (e.g., Version 2 in this example) and the intelligence runtime service 112 sees the deployed version (e.g., Version 1 in this example) as long as the object is deployed.

In accordance with an aspect of the disclosure, modifications (i.e., changes) saved to a parent object to objects are propagated to its child objects. In an embodiment, this propagation is referred to as Object Modification Propagation. For instance, if a source data item of a data source object no longer exists in the data source, when getting the schema, the source data item is deleted. If a dimension object used the non-existent source data item, the change is considered significant because the change directly affects the dimension object. In this case, the dimension object will lose the mapped source of its configuration, which would be evident in both the dimension field editor and the source data item picker. Furthermore, if the dimension object is deployed at the time of this change, system 100 will first clone the dimension object and the change is then applied to the cloned copy (i.e., the next version of the dimension object, as further described herein). This enables deployed objects to execute in the runtime environment unaffected by the modification. In accordance with one or more aspects of the disclosure, Object Modification Propagation is handled for the following scenarios: (1) changes to data source objects propagate to dimension objects and measure objects, (2) changes to dimension links propagate to dimension objects and measure objects, and (3) changes to dimension objects propagate to measure objects.

Changes to data source objects propagate to dimension objects. In an embodiment, actions that trigger changes to data source objects to propagate to dimension objects include getting the schema and saving a custom query. The outcome of these actions is the same. When getting the schema, either a source data item (e.g., source table or view) or source data item field (e.g., source column) may be missing. And when saving a query, the source data item or source data item field of the result set may be missing. Therefore, the result is the same. As used herein, the term missing means that a source data item or the ID of a source data item field (e.g. GUID) has changed. The business rules that determine whether a GUID is changed depends on whether the name has changed, the data type of a source data item field has changed, and/or a key indicator of a source data item field (e.g., PK in the source) has changed. Regarding the name change, for a source data item the relevant determination is whether the namespace and/or object name has changed, and for a source data item field the relevant determination is whether the name has changed.

The following exemplary scenarios illustrate aspects of Object Modification Propagation in accordance with the disclosure.

Scenario 1—During Get Schema, the Source Data Item is Missing:

A Dimension object called “D” is mapped to a Source Data Item “SHIFT”. When getting the schema and Source Data Item “SHIFT” no longer exists in the data source, then:

If the Dimension object was deployed, it is cloned.

The Dimension object's source and all its mappings lose their configuration, although the Dimension Field name and type remain. The rows for the Config.DimensionDataltemFieldMapping source are deleted. The row for the Config.DimensionDataltemMapping Source is deleted.

Scenario 2—During Get Schema Source, the Data Item Field is Missing:

A Dimension Field called “F” is mapped to Source Data Item Field “S”. When getting the schema and the Source Data Item Field “S” no longer exists in the source (i.e., column got dropped or renamed), then:

If the Dimension object was deployed, it is cloned.

The mapping for Dimension Field “F” will lose its source mapping, although the Dimension Field name and type remain. The rows for the Config.DimensionDataltemFieldMapping source are deleted.

Scenario 3—Custom Query is Deleted:

A Dimension object named “D” is mapped to a Custom Query called “GetProducts”. When deleting the Custom Query “GetProducts”, then:

If the Dimension object is deployed, it is cloned.

The Dimension object's source and all its mappings lose their configuration, although the Dimension Field name and type remain. All rows for the Config.DimensionDataltemFieldMapping source are deleted. The row for the Config.DimensionDataltemMapping source is deleted.

Scenario 4—Changing Custom Query Data Set Changed:

A Dimension object named “D” is mapped to a Custom Query called “GetProducts” that has a Data Set Field called “F”. When saving the Custom Query, then:

If the Dimension object is deployed, it is cloned.

The Dimension's Field Mapping loses its configuration, although the Dimension Field name and type remain. The row for the Config.DimensionDataltemFieldMapping source is deleted.

Changes to data source objects propagate to measure objects. When saving changes to an object that is a parent to a child object, the change is said to be significant. For instance, a Data Source object has a Source Data Item Field named ShiftId and that ShiftId is used as a Source Field in a deployed Measure object. This relationship makes the Data Source object a parent of a Measure object. The following exemplary scenarios illustrate aspects of getting a schema when source data items or source data item fields that were bound to a measure object are missing in the source, in accordance with the disclosure. One of ordinary skill in the art will understand that the following exemplary scenarios also apply for changes to a source data item or a source data item field regardless of whether it belongs to a table, a view, or a custom query.

Scenario 5—Calculation Source Field:

A Calculation Source Field called “F” is mapped to Source Data Item Field “S”. When getting the schema and/or re-saving a Custom Query and Source Data Item Field “S” no longer exists in the source (e.g., the column was dropped and/or renamed), and it was mapped to a Measure object's calculation Source Field then:

If the Measure object was deployed, it is cloned.

Any calculations that used the Source Data Item Field “S” remain, but the Calculation Field loses its configuration. The Config.Calculation.FunctionFieldMapping_MappingTypeUID is set to NULL and the Config.Calculation.FunctionFieldMapping_SourceFieldName is set to NULL.

Scenario 6—Calculation Period Field:

A Calculation Period Field called “F” is mapped to Source Data Item Field “S”. When getting the schema and/or re-saving a Custom Query and Source Data Item Field “S” no longer exists in the source (e.g., a column was dropped and/or renamed), and it was mapped to a Measure object's calculation Source Field then:

If the Measure object was deployed, it is cloned.

Any calculations that used the Source Data Item Field “S” remain, but the Period Field loses its configuration. The Config.Calculation. PeriodFieldMapping_MappingTypeUID is set to NULL and the Config.Calculation. PeriodFieldMapping_SourceFieldName is set to NULL.

Scenario 7—Calculation Modification Field:

A Calculation Modification Field called “F” is mapped to Source Data Item Field “S”. When getting the schema and/or re-saving a Custom Query and Source Data Item Field “S” no longer exists in the source (e.g., the column was dropped and/or renamed), and it was mapped to a Measure's calculation Source Field then:

If the Measure object was deployed, it is cloned.

Any calculations that used the Source Data Item Field “S” remain, but the Modification Filed loses its configuration. The Config.Calculation.ModificationPeriodFieldMapping_MappingTypeUID is set to NULL and the Config.Calculation.ModificationPeriodFieldMapping_SourceFieldName is set to NULL.

Scenario 8—Calculation Source:

A Source Data Item called “S” is mapped to Calculation “C”. When getting the schema and/or re-saving a Custom Query and Source Data Item “S” no longer exists in the source (e.g., the table was dropped and/or renamed), and it was mapped to a Measure object's calculations then:

If the Measure object was deployed, it is cloned.

Any calculations that used the Source Data Item “S” remain but the following configured values will lose their configuration: Calculation Source (e.g., Config. CalculationSourceDataltemMapping is deleted), Calculation Field (e.g., Config.Calculation.FunctionFieldMapping_MappingTypeUID is set to NULL, Config.Calculation.FunctionFieldMapping_SourceFieldName is set to NULL), Period Field (e.g., Config.Calculation.ModificationPeriodFieldMapping_MappingTypeUID is set to NULL, Config.Calculation.ModificationPeriodFieldMapping_SourceFieldName is set to NULL), Modification Field (if configured) (e.g., Config.Calculation.ModificationPeriodFieldMapping_MappingTypeUID is set to NULL, Config.Calculation.ModificationPeriodFieldMapping_SourceFieldName is set to ULL), any and all Context Relationship (source) mappings (e.g., Config.RelationshipSourceMapping is deleted, Config.Relationship.RelationshipSourceMappingUID is set to NULL).

Scenario 9—Calculation Context Relationship:

A Calculation Source Field called “F” is mapped to Source Data Item Field “S”. When getting the schema and/or re-saving a Custom Query and Source Data Item Field “S” no longer exists in the source (e.g., the column was dropped and/or renamed), and it was mapped to a Measure object's calculation Source Field then:

If the Measure object was deployed, it is cloned.

Any calculations that used the Source Data Item Field “F” remain but any and all Context Relationship (source) mappings lose their configuration (e.g., Config.RelationshipSourceMapping is deleted, Config.Relationship.RelationshipSourceMappingUID is set to NULL).

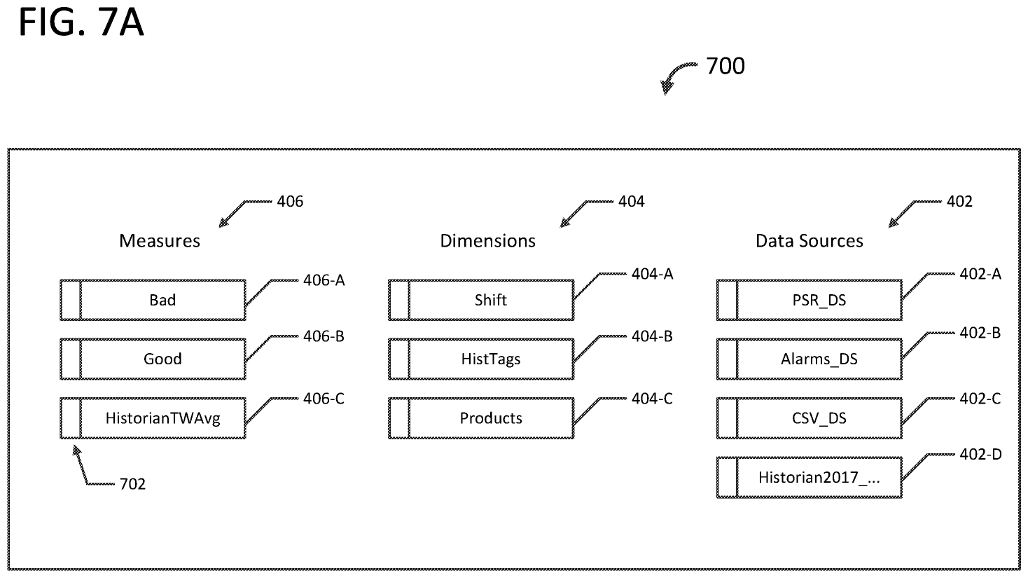

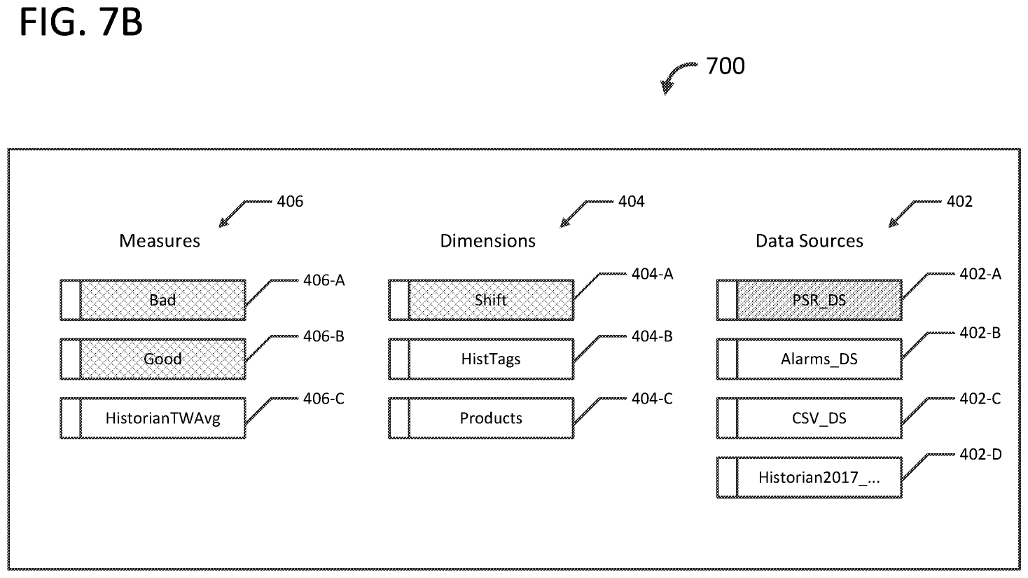

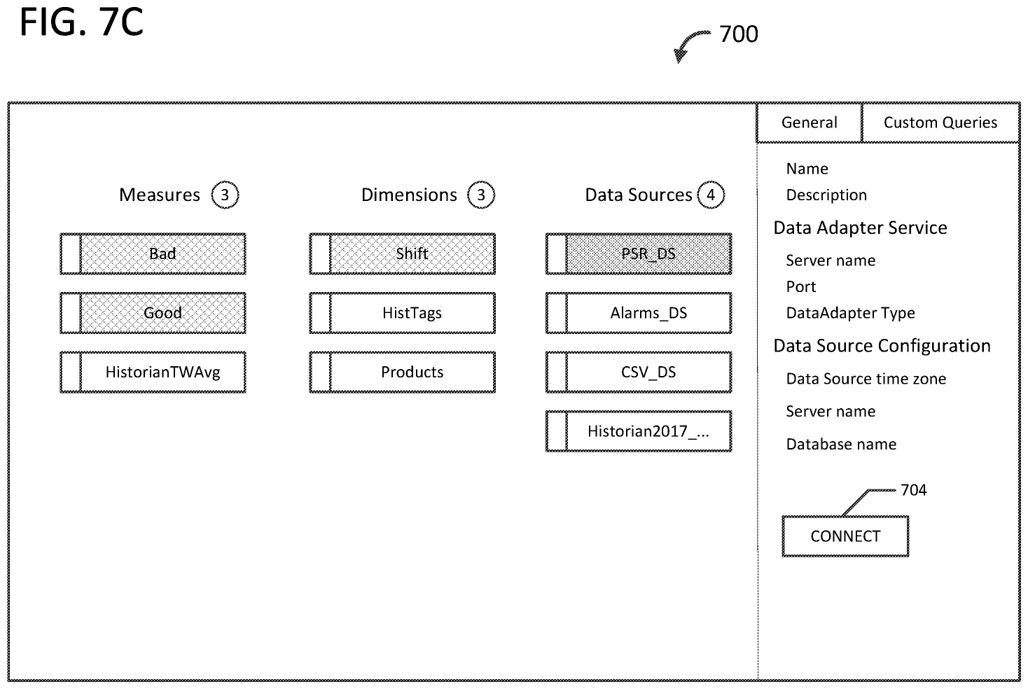

FIGS. 7A-7C illustrate an exemplary graphical user interface (GUI) 700 for data source object 402, dimension object 404, and measure object 406. For example, the GUI may be displayed by client user devices 102. In an embodiment, GUI 700 comprises a model builder. In accordance with an aspect of the disclosure, the GUI provides a multi-dimensional data model visualization that depicts all of the many-to-many, dynamic relationships between different types of objects in a single screen format. Beneficially, the full model visualization with rich context enables authoring of the information model and creation of business dashboards showing key performance indicators based on the models. The GUI includes a clear and full visualization of the entire information model, a full rendering of all relationships between objects (e.g., many-to-many), and a single object in context with all dependencies within the full model. The GUI 700 includes a non-hierarchical graphical representation of one or more instances of the object. For example, graphical representations 402-A through 402-D represent instances of data source object 402, graphical representations 404-A through 404-C represent instances of dimension object 404, and graphical representations 406-A through 406-C represent instances of measure object 406. Although the embodiment illustrated in FIGS. 7A-7C illustrate the non-hierarchical arrangement being columns, one of ordinary skill in the art will understand that other non-hierarchical arrangements are within the scope of the present disclosure. In an embodiment, each graphical representation includes a deployment status indicator 702 that indicates a deployment status (e.g., undeployed, deployed, deployed with pending changes, etc.) of the object instance represented by the graphical representation. For example, each deployment status may have a color associated therewith (e.g., yellow for undeployed, blue for deployed, black for deployed with pending changes, etc.) to visually convey the deployment status of the object instance.

As illustrated in FIG. 7B, in response to selection (e.g., via a single click, etc.) of one of the graphical representations (e.g., 402-A), the object instances (e.g., 404-A, 406-A, 406-B) that are dependent upon the selected model are highlighted (e.g., displayed in a different color, etc.). In an embodiment, the GUI is dynamically updated as new relationships among the objects and/or new objects are added. FIG. 7C illustrates the GUI 700 including a connect button 704 for initiating connections as described further herein.

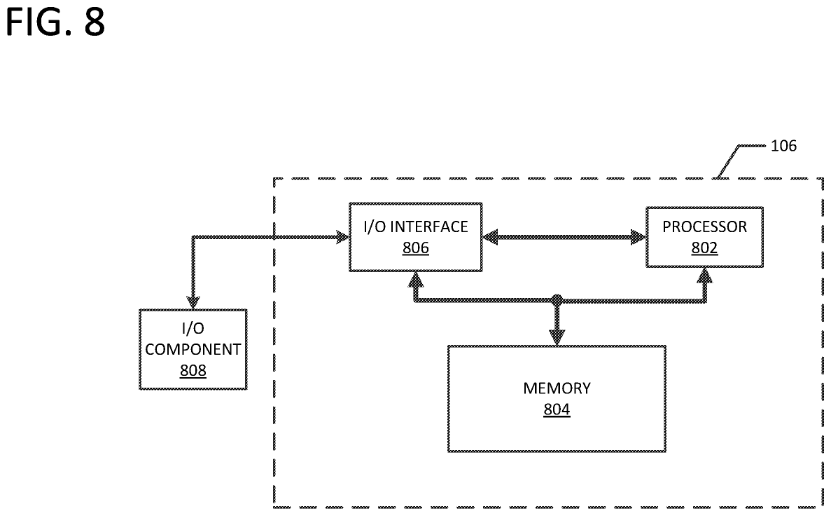

FIG. 8 illustrates an exemplary architecture of a computing device (e.g., client user device 106) programmed to provide aspects of the systems and processes described herein via a software environment. In this embodiment, the computing device includes a processor 802, a memory 804, and an input/output (I/O) interface 806 that interfaces with an I/O component 808. In an embodiment, processor 802 comprises an interface processor. The memory 804 includes processor-executable instructions for executing by processor 802. In this manner, the computing device comprises a special-purpose computing device for providing visualizations of relationships among multi-dimensional data models.

The processor 802, memory 804, and I/O interface 806 are communicatively connected and/or electrically connected to each other. The I/O interface 806 is communicatively and/or electrically connected to the I/O component 808. The processor 802 is configured to execute processor-executable instructions stored in the memory 804 for providing visualizations of relationships among multi-dimensional data models in real time. The I/O interface 806 of FIG. 8 provides a physical data connection between the computing device and I/O component 808. In an embodiment, I/O interface 806 is a network interface card (NIC) or modem and I/O component 808 is a telecommunications network (e.g., communications network 118). Additionally or alternatively, I/O component 808 may be a touchscreen display device.

In an aspect, a computing device (e.g., client user device 106) includes an interface processor (e.g., processor 802) and a computer-readable storage medium (e.g., memory 804) storing processor-executable instructions. The interface processor is communicatively coupled, via a communications network (e.g., communications network 118) and an intelligence data service (e.g., intelligence data service 110), to one or more data sources (e.g., data sources 102) storing data values corresponding to devices of a continuous process (e.g., plant). The data values comprise a plurality of model objects. When executed by the interface processor, the instructions configure the computing device to generate for output graphical representations (e.g., 402-A through 402-D, 404-A through 404-C, 406-A through 406-C, etc.) for a multi-dimensional data model. The graphical representations each represent an instance of one of the model objects (e.g., data source object 402, dimension object 404, measure object 406, etc.). The multi-dimensional data model comprises the plurality of model objects and subsets of two or more of the model objects are related through hierarchical dependencies. The executing instructions further configure the client computing device to output for display the graphical representations in a non-hierarchical arrangement (e.g., GUI 700, etc.) and receive an input to select one of the model objects by selecting the graphical representation (e.g., 402-A) representative of the model object. And the executing instructions configure the client computing device to output for display a filtered view of the graphical representations (e.g., 404-A, 406-A, 406-B). The filtered view comprises the selected graphical representation and the graphical representations representing the subset of model objects dependent upon the model object represented by the selected graphical representation. The graphical representations representing the dependent model objects in the filtered view are graphically distinguished (e.g., via a different color, etc.) from the graphical representations (e.g., 404-B, 406-C, etc.) representing the model objects that are independent of the model object represented by the selected graphical representation.

In an embodiment, the processor-executable instructions include instructions that, when executed by the processor, configure the computing device to output for display an updated view of the graphical representations when at least one of the relationships of hierarchical dependencies among the model objects changes. In this embodiment the updated view including the graphical representations is updated to reflect the changed relationships.

In yet another embodiment, the processor-executable instructions include instructions that, when executed by the processor, configure the computing device to output for display an updated view of the graphical representations when at least one new model object is added to the multi-dimensional data model. In this embodiment the updated view includes a new graphical representation representing the new model object.

In another embodiment, the model objects are stored in an intelligence data store (e.g., data store 116, etc.) of the intelligence data service in accordance with a configuration schema (e.g., FIGS. 3A-3H). In one form, the computing device is communicatively coupled to the intelligence data store via a communications network (e.g., communications network 118).

In yet another embodiment, the model objects include one or more of data source objects (e.g., data source object 402), dimension objects (e.g., dimension object 404), and measure objects (e.g., measure object 406). In one form, the data source object is dependent upon the dimension object and the measure object and the dimension object is dependent upon the measure object.

In another embodiment, the processor-executable instructions include instructions that, when executed by the processor, configure the computing device to create a second version of the model objects having a first version that is deployed in a runtime environment for making changes to the model object without interrupting the deployed first version of the model object.

Embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter 48. In addition to the monitor, personal computers typically include other peripheral output devices (not shown), such as speakers and printers.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1-20. (canceled)

21. A server system comprising:
a server computer including one or more computers comprising one or more processors and one or more non-transitory computer readable media, the one or more non-transitory computer readable media including instructions stored thereon that when executed cause the one or more computers to implement:
deploy, by the one or more processors, a version 1 data source object;
receive, by the one or more processors, a change to the version 1 data source object from a user interface of a client device;
generate, by the one or more processors, a version 2 data source object;
store, by the one or more processors, the version 2 data source object in a configuration database;
receive, by the one or more processors, a request API call from the client device; and
return, by the one or more processors, the version 2 data source object from the configuration database to the user interface;
wherein the version 2 data source object comprises a copy of the version 1 data source object.

22. The server system of claim 21,
wherein when the version 2 data source object is generated, the version 1 data source object stays unchanged.

23. The server system of claim 21,
wherein when the version 2 data source object is generated, a source data items and a source data item fields of version 1 remain unchanged.

24. The server system of claim 22,
wherein when the version 2 data source object is generated, a source data items and a source data item fields of version 1 remain unchanged.

25. The server system of claim 21,
wherein a model application programming interface (API) controls all data writes into a configuration database and data reads out of the configuration database.

26. The server system of claim 21,
wherein once an object is deployed to a runtime environment, a model application programming interface (API) prevents changes to the deployed object.

27. The server system of claim 21,
wherein one or more data sources are configured to store data indicative of one or more values corresponding to a plant process.

28. The server system of claim 27,
wherein the one or more data sources are configured to provide stored data to the server computer via a communications network.

29. The server system of claim 21,
wherein once the version 1 data source object is deployed to a runtime environment, a model application programming interface (API) prevents changes to the version 1 data source object.

30. The server system of claim 29,
wherein the server computer includes the model API.
